(19) United States
(12) Patent Application Publication
(10) Pub. No.: US 2014/0258037 A1
(43) Pub. Date: Sep. 11, 2014

(54) Transparency in Processing of Wait Times for Brokered Engagements

(71) Applicant: AMERICAN WELL CORPORATION, Boston, MA (US)

(72) Inventor: Roy Schoenberg, Boston, MA (US)

(73) Assignee: AMERICAN WELL CORPORATION, Boston, MA (US)

(21) Appl. No.: 13/792,552

(22) Filed: Mar. 11, 2013

(51) Int. Cl. G06Q 30/06

(52) U.S. Cl. CPC G06Q 30/0613
USPC 705/26.41

(57) ABSTRACT

Described are techniques for providing broker services to consumers and service providers. An estimate of when a service provider will be available to the consumer is calculated based on determining entries in a queue maintained for the service provider, the entries corresponding to consumers waiting for the service provider. An entry corresponding to the consumer is added to the queue maintained for the service provider, and the estimate is sent to a device used by the consumer; and when the consumer in the queue is at the top of the queue a real-time communication channel is established with a device used by the consumer.

### BACKGROUND

The present disclosure is directed to connecting consumers with service providers.

Systems have been developed to connect consumers and their providers over the Internet and the World Wide Web. Some systems use e-mail messaging and web-based forms to increase the level of connectivity between a member of a health plan and his assigned health care provider. The consumer sends an e-mail or goes to a website that generates and sends a message (typically an e-mail or an e-mail type message) to a local provider. These types of services have been broadly referred to as “e-visits.” Other health care solutions include technologically advanced telephone communication solutions that use advances in voice communication and data transmission technology to interconnect medical professionals with patients.

### SUMMARY

According to an aspect, a computer-implemented method includes receiving from a consumer a request to consult with a service provider, calculating by one or more computers an estimate of when a service provider will be available to the consumer, based on determining entries in a queue maintained for the service provider, the entries corresponding to consumers waiting for the service provider, adding by the one or more computers an entry corresponding to the consumer to the queue maintained for the suitable service provider, sending by the one or more computers the estimate to a device used by the consumer, and when the consumer in the queue is at the top of the queue, causing by the one or more computers establishment of a real-time communication channel with a device used by the consumer.

According to an aspect, a computer program product tangibly stored on a computer readable storage device for providing broker services to consumers and service providers, the computer program product comprising instructions for causing a computer to receive from a consumer a request to consult with a service provider, calculate an estimate of when a service provider will be available to the consumer, based on determining entries in a queue maintained for the service provider, the entries corresponding to consumers waiting for the service provider, add an entry corresponding to the consumer to the queue maintained for the suitable service provider, send the estimate to a device used by the consumer; and when the consumer in the queue is at the top of the queue, cause establishment of a real-time communication channel with a device used by the consumer.

According to an additional aspect, an apparatus includes a processor, memory in communication with the processor, and a computer program product stored on a computer readable medium for providing broker services to consumers and service providers, the computer program product comprising instructions for causing the processor to receive from a consumer a request to consult with a service provider, calculate an estimate of when a service provider will be available to the consumer, based on determining entries in a queue maintained for the service provider, the entries corresponding to consumers waiting for the service provider, add an entry corresponding to the consumer to the queue maintained for the suitable service provider, send the estimate to a device used by the consumer; and when the consumer in the queue is at the top of the queue, cause establishment of a real-time communication channel with a device used by the consumer.

The following are some of the features within the scope of the above aspects.

The estimate is based on a number of entries corresponding to other consumers ahead of the entry of the consumer in the queue. A graphical user interface is populated with the estimate. For each entry added to the queue an estimate of an amount of time to allocate to each entry is determined and the estimate of the amount of time is associated with the corresponding entry in the queue. The estimate is calculated for when the service provider will be available to the consumer by determining which entries in the queue have a higher priority than a priority of the consumer and adding by the one or more computers allocated times of those entries in the queue that represent consumers having a higher priority than the consumer to calculate estimate. A list of suitable service providers is determined by matching attributes of service providers to metrics that define a suitable service provider that meets the consumer's preferences and receiving a selection one of the suitable service providers from the consumer providing the service provider. Entries of consumers in the queue are assigned a priority by executing a priority algorithm. Estimates of lengths of the time of engagement by the consumers with the service provider are calculated, and the calculated estimates are added to entries for the consumer and a total length of times of engagement for those other consumers, having priorities greater than a priority of the consumer are calculated and the calculated total length is sent to the device used by the consumer. An entry is deleted corresponding to a first one of the consumers waiting for the provider when the consult is completed and entries in the queue corresponding to the remaining ones of the consumers waiting and the consumer are promoted. The request from the consumer includes medical information of the consumer for use during a consultation with the service provider.

One or more of the following advantages may be provided by one or more of the above aspects.

Consumers can engage with the system using various modalities, including registered user, guest user and anonymous user. In particular an anonymous user modality is very useful for those types of individuals that may have serious issues, but which are generally reluctant to discuss issues with strangers.

### BRIEF DESCRIPTION OF THE FIGURES

FIG. 1 is a diagrammatic view of an arrangement including a brokerage system.

FIG. 2 is a flow chart of an estimation process.

FIG. 3 is block diagram of an availability process.

FIG. 4 is a block diagram of a record.

FIGS. 4A and 4B are block diagrams of queue structures.

FIG. 5 is a block diagram of an alternative queue structure.

### DETAILED DESCRIPTION

Overview

The system described below provides an integrated information and communication platform that enables consumers of services to access service providers to consult and to carry out such consultations in an efficient manner. Consumers are able to consult with an expert service provider even when the two parties are geographically separated. This integrated platform is referred to as a brokerage system (or depending on the context brokerage service).

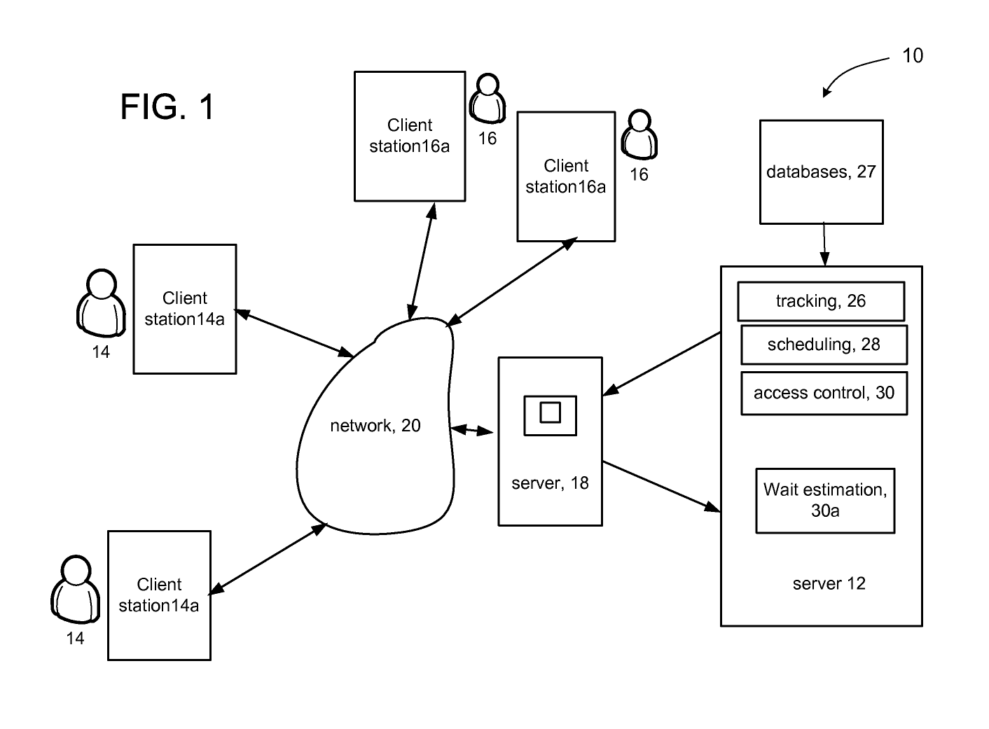

Referring now to FIG. 1, an exemplary networked computer system 10 including engagement brokerage functionality also includes a computerized system or server 12 for processing requests from consumers 14 at client systems 14a to engage with providers 16 at provider systems 16a. The networked computer system 10 implements a brokerage service embodied as web-based engagement brokerage. The networked computer system 10 includes a web server 18 to receive on-line web-based requests and which provides web-based communication channels between a provider and a consumer using a web browser or the like.

The server 18 receives a request for a consultation a graphical user interface or the like. The request is parsed to identify the particular ailment or concern, etc. of the patient 14. The server 12 includes an availability or presence tracking module 26 for tracking the availability of the service providers 16. Availability or presence is tracked actively or passively. In an active system, one or more of the service providers 16 provides an indication to the server 12 that the one or more service providers are available to be contacted by consumers 14 and an indication of the mode by which the provider may be contacted. In some examples of an active system, the provider's computer, phone, or other terminal device periodically provides an indication of the provider's availability (e.g., available, online, idle, busy) to the server 12 and a mode (e.g., text, voice, video, etc.) by which he can be engaged. In a passive system, the server 12 presumes that the service provider 16 is available by the service provider's actions, including connecting to the server 12 or registering the provider's local phone number with the system. In some examples of a passive system, the server 12 indicates the provider 16 to be available at all times until the provider logs off, except when the provider is actively engaged with a consumer 14.

The server 12 also includes one or more processes in addition to the tracking module 26, such as a scheduling module 28. The server 12 accesses one or more databases 27. The components of the server 12 and the web server 18 may be integrated or distributed in various combinations as is commonly known in the art.

The networked computer system 10 allows a consumer 14 to communicate with a provider 16. The consumer 14 and provider 16 connect to the server 12 through a website or other interface on the web server 18 using client devices 14a and 16a, respectively. Client devices 14a and 16a can be any combination of, e.g., personal digital assistants, cell phones, computer systems, media-player-type devices, and so forth. The client devices 14a and 16a enable the consumers 14 to input and receive information as well as to communicate via video, audio, and/or text with the providers 16.

At the instant a consumer 14 desires to connect and communicate with a provider, the server 12 determines whether that provider is available. If that particular provider 16 is available, the server 12 assesses the various modes of communication that are available forwards connection information of the consumer 14 to the service provider 16 through one or more common modes of communication. The system selects a mode of communication to use based in part on the relative utility of the various modes. If the provider is not available, the server 12 invokes a wait estimate process 30a (discussed below).

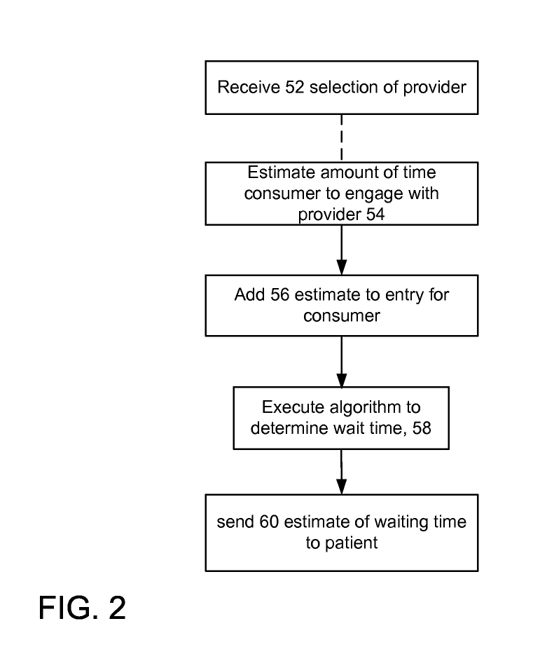

A mode of engagement has both the consumer 14 and the provider 16 use web-based consoles, as this allows each of the other modes to be used as needed. For example, consumers and providers may launch chat sessions, voice calls, or video chats from within a web-based console like that shown in FIG. 2A, below. A web based console also provides on-demand access to records, such as the consumer's medical history, and other information. If only one of the participants in an engagement has access to a web console, the server 12 connects that participant's console to whatever form of communication the other party has available. For example, if the consumer is on the phone and the provider is using a web browser, the server 12 may connect the consumer's phone call to a VoIP session that the provider can access through the web. If the provider 16 is not available, the server 12 identifies other available providers 16 that would meet the consumer 14's needs. The server 12 enables the consumer 14 to send a message to the consumer's chosen provider.

The server 12 includes an access control facility 30 that manages and controls whether a particular consumer 14 can access the networked computer system 10 and what level or scope of access to the features, functions, and services the networked computer system 10 will provide. The server also includes the wait estimation processing 30a that determines a consumer's wait time according to an algorithm that manages provider queues.

One advantage that the brokerage provides is that the brokerage constantly monitors the availability of a provider for an engagement. Thus, consumers regardless of modality receive relatively quick attention to address their questions or concerns. The server 12 can cause a communication channel to be established between the consumer and the provider via a web browser or the like. The server 12 identifies service providers 16 that are available at any given moment to communicate with a consumer about a particular product, service, or related topic or subject, for example, a medical condition.

In order to achieve such a level of availability, the networked computer system 10 assimilates the discretionary or fractional availability windows of time offered by individual providers at stations 16a into a continuous availability perception by consumers. Consumers will have little expectation that the same provider will be constantly available, rather, they expect that some provider will be available.

By way of illustration, the networked computer system 10 services patients that are members of healthcare plans. For example, the service providers 16 may be physicians, and the service consumers 14 may be patients. The service providers and service consumers may also be lawyers and clients, contractors and homeowners, or any other combination of a provider of services and a consumer of services.

The system enables the consumer to search for providers that are available at the time the consumer is searching, and enables the consumer to engage a provider on a transactional basis or for a one-time consultation. A consumer can use the system for various purposes, such as a consultation or second opinion. An example of details of a brokerage system is discussed in my U.S. Pat. No. 7,590,550 entitled: “Connecting Consumers with Service Providers”, the contents of which are incorporated herein in its entirety.

Referring now to FIG. 2, an exemplary wait estimation processing 30a is shown. The server 12 receives 52 the selection of service provider, either by a provider determined from the system or a provider selected by the consumer, e.g., patient, as discussed above. The request includes relevant information, which in the case of a patient is relevant medical information for use during the consultation. The server estimates 54 an amount of time that the consumer will use to engage with the provider. Calculating an estimate of a length of the time of engagement by the consumer with the service provider can be based on several factors including the efficiency history of the provider, type of condition of the patient, availability of records, so forth. The allocation of the amount of time for each entry can be entered manually based on an initial triage or can be calculated automatically, based on factors associated with the request. The server 12 adds 56 the calculated estimate for the consumer to an entry for that consumer. The server determines 58 a wait time and the server 12 sends 60, the consumer an estimate of the waiting time. The server sends 60 the estimate via a generated graphical user interface that is populated with the estimate.

The server determines the wait time by adding the calculated estimates for entries for consumers ahead of the particular consumer in the queue to provide a total length of calculated times of engagement for those consumers having priorities greater than a priority of the consumer. The server bases the estimate on the number of entries corresponding to other consumers that are ahead of the consumer.

When the consumer in the queue is at the top of the queue, the server causes establishment of a real-time communication channel with a device used by the consumer. The server deletes entries corresponding to consumers when the consult is initiated and/or completed, and promotes entries in the queue corresponding to the remaining ones of the consumers waiting. In some embodiments the consumer entries in the queue are ordered by executing a priority algorithm.

By exposing the time when a provider will become available, this enables better and more efficient utilization of the server. It gives the consumer flexibility allowing the consumer to engage in other tasks rather than merely just waiting for the provider to become available.

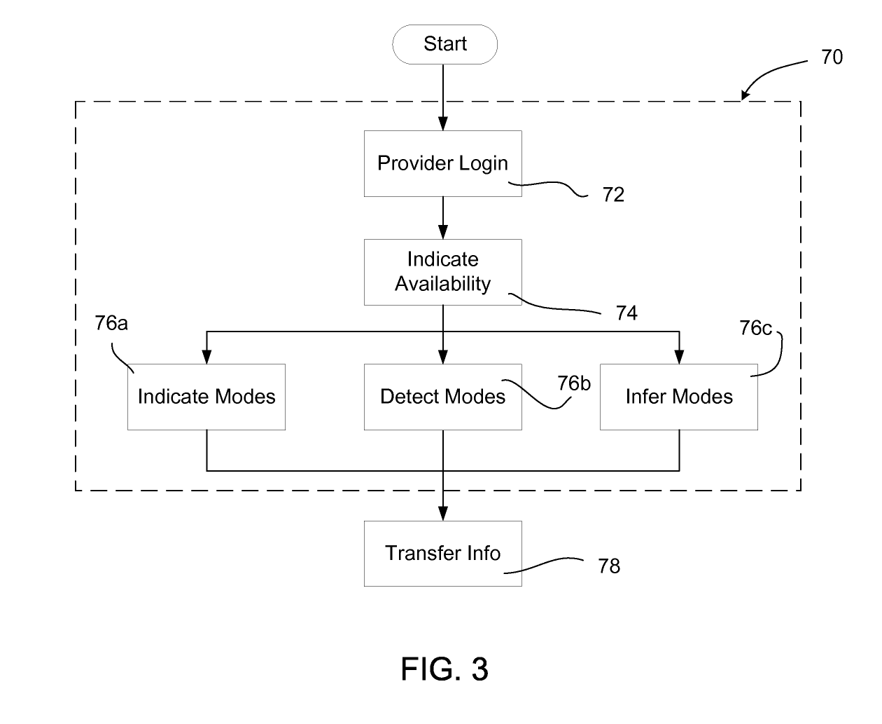

Referring now to FIG. 3, the server 12 tracks 70 the availability of providers 16 and in some embodiments, on-line consumers 14. When a provider 16 logs 72 into the networked computer system 10, the provider 16 indicates 74 (such as by setting a check box or selecting a menu entry or by responding to a voice prompt) to the tracking module 26 that he or she is available to interact with consumers 14. The provider 16 can also indicate 76a to the tracking module 26 (such as by setting a check box or selecting a menu entry or by responding to a voice prompt) the modes (e.g., telephone, chat, video conference) by which a consumer 14 can be connected to the provider 16.

Alternatively, the tracking module 26 determines 76b the capabilities of the terminals 14a and 16a the consumer 14 and the provider 16 use to connect to the system (for example, by using a terminal-based program to analyze the hardware configuration of each terminal). Thus, if a provider 16 connects to the networked computer system 10 by a desktop computer and the provider has a video camera connected to that computer, the tracking module 26 determines that the provider 16 can be engaged by text (e.g., chat or instant messenger), voice (e.g., VoIP) or video conference. Similarly, if a provider 16 connects to the system using a handheld device such as a PDA, the tracking module 26 determines that the provider 16 can be engaged by text or voice, whereas, if the consumer connects to the networked computer system 10 via a telephone for a telephonic engagement the provider will reply with a telephone call to the consumer. The tracking module 26 can also infer 76c a provider's availability and modes of engagement by the provider's previously provided profile information and the terminal device through which the provider connects to the system. The availability information can be transferred 78 to scheduling.

Providers participating in the brokerage system 10 can have several states of availability at different times. States in which the provider may be available include “on-line”, in which the provider is logged-in and can immediately accept new engagements in any mode, “on-line (busy)”, in which the provider is logged-in but is currently occupied in another engagement, and “scheduled”, in which the provider is offline but is scheduled to be online at a designated time-point and can pre-schedule engagements for it. A provider can also be not-logged in and thus unavailable.

Also, while not online, the provider can take messages as in offline state. Thus, another state includes off-line, in which the provider is not logged in but can take message-based engagements (i.e., asynchronous engagements), out-of-office, in which the provider is not accepting engagements or messages, and “on call”, in which the provider is offline and can be paged to go to on-line status by the brokerage network if traffic load demands it (in some examples, consumers see this state as offline).

The operating business model for the provider network employs a remuneration scheme for providers that helps assure that the consumers can find providers in designated professional domains in the online mode. For example, selected providers can be remunerated for being in the on-call mode to encourage on-line availability in case of low discretionary availability by other providers in their professional domain. On-call providers are also called into the on-line state when the fraction of on-line (busy) provider's domain exceeds a certain threshold.

In certain embodiments, the provider can be presented with a user interface (not shown) that enables the provider to selectively control his/her availably across provider networks and provider practices.

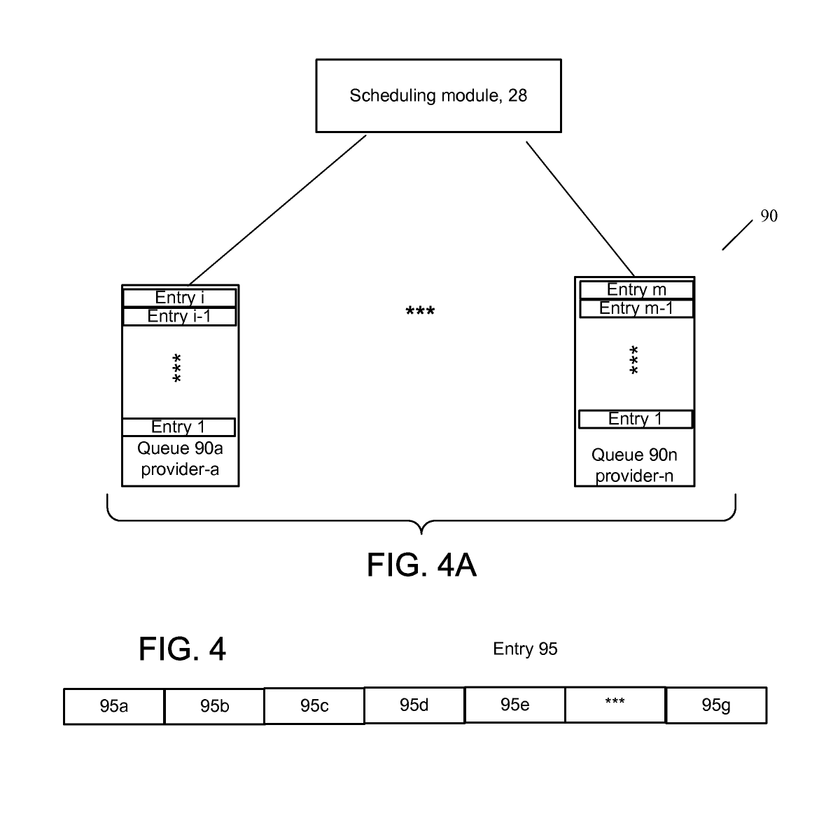

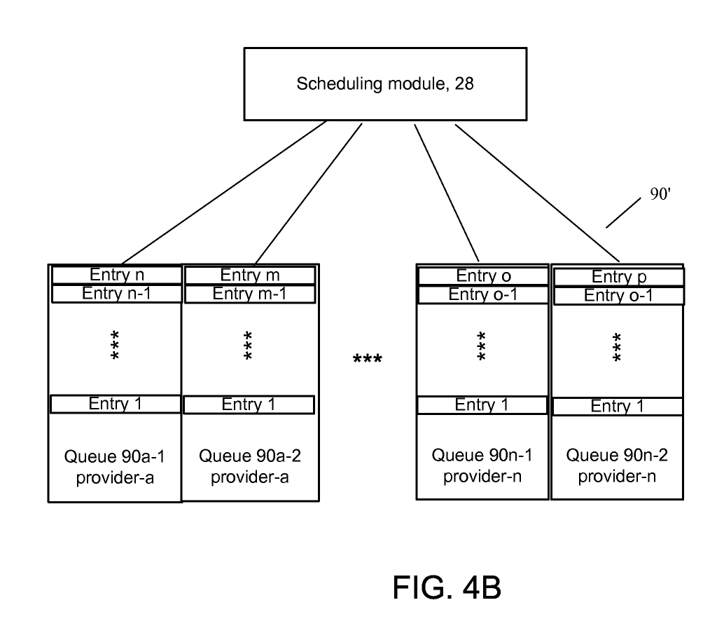

Referring now to FIG. 4, a consumer (e.g., patient) record 125 is shown. This record 125 is retrieved, e.g., from a queue consumers waiting to be serviced by a provider or from a database based on retrieving an entry from the queue of consumers waiting to be serviced by a provider. The record 125 includes various items 125a-n of information regarding the consumer.

Referring now to FIG. 4A, the tracking module 26 (FIG. 1) transfers 78 (FIG. 3) information about the availability of providers 16 and the communication capabilities of the consumers 14 and the providers 16 to the scheduling module 28. The scheduling module 28 uses the tracking information to schedule providers with consumers.

In one embodiment, each provider, e.g., “provider-a” to “provider-n” is associated with a queue, e.g., 90a-90n, respectively. The queue for each provider is filled by the server 12 with entries (as depicted as entries 1 through i and entries 1 through m) that correspond to requests for consultations with a provider. More specifically, as consumers access the networked computer system 10 and are processed through the intake process, entries representing the consumers are produced by the server 12 and those entries are queued.

In one embodiment, the server 12 stores the entries in queues of those providers that the server determines has the least number of entries, in order to balance provider utilization across the system 10, and to otherwise minimize overall response time for consumers. The server 12 produces an entry for storage in one of the queues (generally 90). The server 12 examines the queues 90a-90n of all providers that are suitable to provide a consultation with the consumer and the server chooses the queue of a suitable provider that has the least number of entries waiting to be processed. The queue, e.g., queue 90a of the chosen provider (provider-a) is loaded with that entry.

To select entries from the queue, the server 12 uses in one embodiment a first in first out priority scheme to retrieve an entry from the query. That is, in servicing consumer requests, for a particular provider, the server 12 retrieves the entry of a consumer that is next to be serviced (the oldest entry in the queue 90). As the provider services that consumer, the server 12 removes the corresponding entry from that provider's queue and the server 12 promotes all remaining entries in that queue such that the next entry in the queue to be serviced will be now be the oldest entry.

However, in an alternative embodiment the next server applies a priority scheme based on a priority designation of patients with those designated as “high priority” being given precedence over lower priority designations. Any number of priority designations can be used, with three being a workable number of designations. Priority designations can be based on an initial triage that is made during an intake process using either a triage algorithm or a service representative's assessment based on information obtained during intake. Many factors can be considered including, e.g., severity of conditions, degree of overuse of the brokerage system either by specific individuals or collectively by individuals in provider practices, e.g., associated with a sponsor (e.g., an employer/plan), specific employer and/or plan, etc. Priority can also be based on specific online practices (e.g., patients coming in through the “Emergency Management” practice are higher priority than the “Flu” practice). Priority can consider multiple ones of those factors. For example, the priority algorithm can give precedence to the patient triaged with high priority based on severity of medical conditions and which is the oldest in the queue.

With the factor-based priority scheme, for servicing consumer requests for a particular provider, the server 12 retrieves the entry of a consumer that is next to be serviced at a priority designation that is currently the highest designation having entries in the queue 90. As the provider services that consumer, the server 12 removes the corresponding entry from that provider's queue and the server 12 promotes all remaining entries in that queue at that designation such that the next entry in the queue to be serviced will be now be the oldest entry at that priority designation. When all entries have been serviced from the queue with at that priority designation, the server will retrieve the entry of a consumer that is next to be serviced at a priority designation in the queue 90 that is the next lowest priority. The server 12 can also monitor the queues to insure that the queues are not filled with high priority designations for one provider at such a rate that the provider cannot service lower priority designations.

Referring now to FIG. 4B, in an alternative embodiment, the queues (generally 90′) for each provider are sub-divided or represented as plural sub-queues with each of the sub-queues corresponding to an appointment “state.” In FIG. 4B, two queues 90a-1 to 90a-2 and 90n-1 to 90n-2 are shown for each of the providers, e.g., “provider-a” to “provider-n” with the sub-queues 90a-1 to 90a-2 and 90n-1 to 90n-2 representing, “waiting room” and “scheduled appointments” of the respective providers “provider-a” to “provider-n.”

In this embodiment, the server 12 using scheduling module 28, examines the queues of all providers that are suitable to provide a consultation with the consumer and chooses the appropriate sub-queue of a suitable provider that has the least number of entries waiting to be processed for the particular state, e.g., “waiting room” and “scheduled appointments.” More specifically, for “telephonic engagements” the server loads entries into the waiting room queue of the particular provider that has the fewest entries.

In servicing requests, for a particular provider, the system retrieves the entry of a consumer that is next to be serviced from the waiting room for that provider. The next to be serviced is according to the following priority the oldest entry in the waiting room. In brokerage systems that allow for telephonic generated requests with provider call-backs the oldest entry priority would be adjusted when the server determines that the scheduled appointment queue of the provider has either an entry for a scheduled telephonic callback or scheduled appointment that has an scheduled appointment time that is either equal to the current time or would be within a time window where the servicing of a waiting room entry or a new request would adversely impact servicing of scheduled telephonic callback or scheduled appointment queued entries. For example, in some embodiments the system
could allocate a set time period of, e.g., 15 minutes to service a request. Accordingly, the server 12 would not select an entry from the waiting room queue if there was a scheduled appointment in, e.g., 10 minutes.

Telephonic engagements without any scheduling will generally be placed in and thus serviced from the waiting room sub-queue. As the provider services a consumer from its sub-queue all remaining entries (representing other consumers) in that sub-queue are promoted such that the next entry in the sub-queue to be serviced will be the next oldest entry.

In another embodiment, the server 12 applies a priority scheme based on a priority designation of patients, as discussed above. Again, the priority designations are based on an initial triage made during an intake process considering several of the above mentioned factors.

With the factor-based priority scheme, for servicing consumer requests for a particular provider, the server 12 retrieves the entry of a consumer that is next to be serviced at a priority designation that is currently the highest designation having entries in either one of the provider's queues 90′. As the provider services that consumer, the server 12 removes the corresponding entry from that provider's queue and the server 12 promotes all remaining entries in that queue at that designation such that the next entry in the queue to be serviced will be now be the oldest entry at that priority designation. When all entries have been serviced from the queue with at that priority designation, the server will retrieve the entry of a consumer that is next to be serviced at a priority designation in the queue 90 that is the next lowest priority.

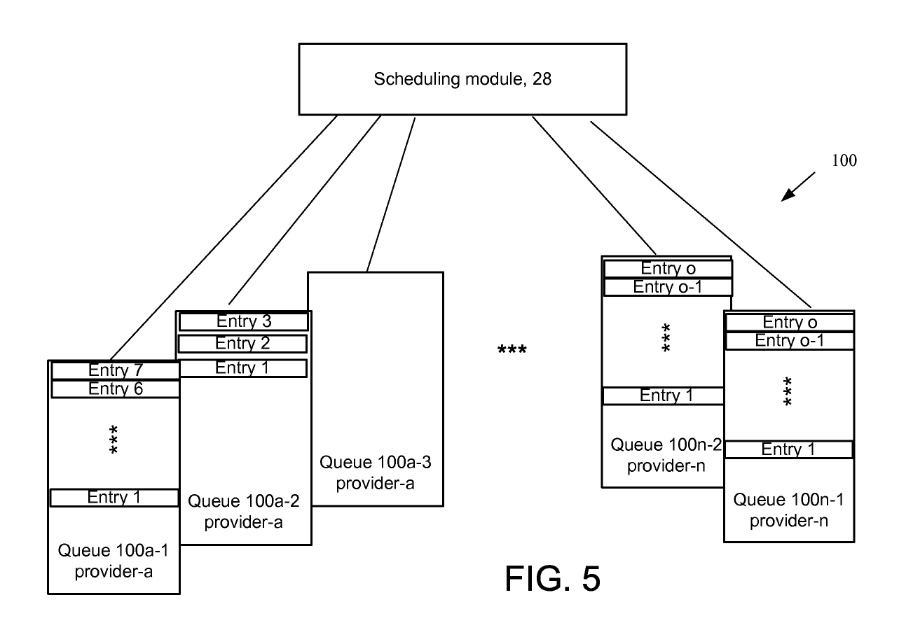

Referring now to FIG. 5, an alternative queue structure 100 is shown. In this alternative embodiment, the queues (generally 100) for each provider are sub-divided or represented as plural sub-queues with each of the sub-queues corresponding to a provider network 144 (FIG. 6). Thus, three queues 100a-1 to 100a-3 are shown for the provider corresponding to the particular example of the interface shown in FIG. 6, and queues 100n-1 to 100n-2 are shown for a provider “n”, which has only two provider networks with which the provider-n is associated, and which would be associated with a different instance of the interface (not shown).

The sub-queues 100a-1 to 100a-3 and 100n-1 to 100n-2 represent provider networks but as with the queue structure described in FIG. 4B those queues could be further sub-divided into, “waiting room” and “scheduled appointments” states of the respective providers “provider-a” to “provider-n.”

Modes of Engagement

Telephonic Callbacks

Consumers who wish for a telephonic consultation with a provider may use a traditional telephone to enter information, as discussed above, and hangs up and waits for a call-back from a suitable provider, as also discussed above. Providers are sent information concerning the consumer in order to understand the consumer's issue and a telephone number by which the provider contacts the consumer.

In some embodiments of the networked computer system 10, the networked computer system 10 allows consumers to engage provider's e.g., health professionals “on demand” based on provider availability. These engagements can be established in various ways as described in the above mentioned patent. These types of engagements include:

Passive Browsing

Reference health content is accessed on the brokerage's website. The website can support the use of licensed content packages from other vendors to meet the variable preferences of health plans. For example, key content vendors include Healthwise™, ADAM™, Mayo Clinic™ and HealthDay™. Content libraries provided by such vendors offer a combination of articles, imagery, interactive tutorials and related tools that allow consumers to access content relevant for their health issues. Many health plans and major employers already possess a license for the use of one of these content packages.

Health Risk Assessments

The system acquires information from consumers through automated interaction (e.g., rules-based interaction) in order to crystallize their needs (e.g., medical risks) and better direct them. Assessments span from general health to very specific medical conditions and follow a path of questioning that dynamically tailors itself based on information already retrieved (e.g., using predefined rules). As assessments progress, the system constructs engagement suggestions that the consumer can exercise. Each suggestion represents both the question to the provider and the type of provider appropriate to answer it. Consumers may choose to simply launch such engagements or apply their own discretion as to the phrasing and the selection of the recipient provider. This is discussed in more detail below in the context of the consumer advisor.

Asynchronous Correspondence

The lowest level of true provider interaction is by way of secure messaging. The question or topic of the engagement is sent to a selected provider (whether online or not) and can be answered by this provider at her leisure. Turnaround times are monitored by the system and are part of the credentials of the provider used for her selection by consumers. The system informs the consumer once a response has been received and can allow the consumer to redirect the question if he needs more urgent response time. For example, typical types of asynchronous correspondence include e-mail, instant messaging, text-messaging, voice mail messaging, VoIP messaging (i.e., leaving a message using VoIP), and paper letters (e.g., via the U.S. Postal Service).

Synchronous Correspondence

Several forms of synchronous correspondence allow the consumer and the provider to engage in real-time discussions.

Synchronous Text Correspondence

This may be referred to as a “Chat” module where both sides of the engagement type their entries in response to each others' entries. The form of communication may be entirely text based but is still a live communication. Examples include instant messaging and SMS messaging.

Web-Based Teleconferencing

The use of broadband network connections allows for real-time voice transmission over the Internet in what is referred to as full duplex (i.e., both voice channels are open at the same time). Consumers can opt to have a voice conversation with their providers using, for example, their computer's speakers and microphone. Web-based teleconferencing may use VoIP, SIP, and other standard or proprietary technologies.

Telephonic Conferencing

Consumers who wish for a direct telephonic communication with a provider or who are not comfortable using their computer may use a traditional telephone for interaction with a provider. The consumer may use a dial-in number and an access code that connects him to the brokerage's servers. Providers are linked to the servers via VoIP, other data-network-based voice systems, or their own telephones. Telephonic conferencing may also allow consumers to request “call me now” functions, in which the provider calls the consumer (directly or through the brokerage).

Video Conferencing

The system can support video conferencing to allow consumers to exhibit physical findings to providers if such disclosure is needed. Consumers and providers may also simply prefer face-to-face communication, even if remote. Small digital cameras, referred to as webcams, attached to or built in to personal computers or laptops can be used for this purpose. Video conferencing can be provided by standard software or by custom software provided by the brokerage. Alternatively, dedicated video conferencing communication equipment or telephones with built-in video capabilities can be used.

Semi Synchronous Correspondence

Some engagements of a consumer with an online provider include both synchronous and asynchronous interactions. Part of the engagement takes place by immediate messaging between the two, but the provider may ask the consumer to take occasional asynchronous assessments if, for example, a generic line of question is desired. This allows the provider to operate more than one consumer engagement at a time while each consumer is constantly engaged. For example, semi-synchronous correspondence includes a combination of e-mail, instant messaging, test messaging, voice calls and mail messaging, and VoIP calls and VoIP messaging.

Interactive Voice Response Engagements

Interactive Voice Response (IVR) systems allow for the deployment of interactive audio menus over the phone. The caller can navigate between options, listen to data-driven information, provide meaningful input, and engage system functions. IVR engagements extend the reach of the system to the telephone as a portable consumer interface to launch an engagement in addition to the Web-based interface. Consumers select a pin code on the application to authenticate their identity if they call in. Several types of engagements can be carried out through an IVR system using suitable logic such as described in the patent. For dial-in engagements, the consumer calls in and invokes a telephonic engagement with an available provider. The IVR system extends the consumer's ability to select a provider to the phone so that the consumer's interaction resembles one carried out on the Web.

The IVR system can also be used proactively to pursue consumers who need a follow-up. At the time of a follow-up, the system recalls the provider with whom the follow-up is desired (or the type of provider in case the follow-up is not restricted to a specific provider), identifies that the provider is available for an engagement, and attempts to contact the consumer over the phone to establish a connection for the engagement. Once contacted, the consumer can decline or ask postpone the call. If the consumer takes the call, the connection is made. When consumers are pursuing an engagement with a provider that is either busy or currently offline, the IVR system allows the consumer to park in a standby mode until the provider is available. When the provider is available, the system calls the consumer, identifies the provider to the consumer, and verifies that the consumer is still interested in pursuing the call with the provider. If the consumer is still interested, an engagement is connected.

In addition to launching engagements, the IVR interface allows consumers to interact with other services offered by the brokerage. For example, consumers can instruct the system to fax a transcript of their information to a fax machine that the consumer identifies by keying in or speaking its phone number. Using such a function, a consumer makes key information available to, e.g., emergency room personnel or to a provider in an office visit, without the need to plan, collect, print, and carry the information to that encounter.

IVR hardware is readily available from telecommunication vendors and can be programmed to operate in the context of the brokerage framework. Authentication is provided through a PIN number or by other standard methods.

The consumer information collected by the intake process may be stored in the databases 27 as part of the overall brokerage system. In some examples, the consumer information is protected and secured from unauthorized access and in compliance with the various legal requirements for storing private consumer information (for example, HIPPA governs access to an individual's health care information). The database 27 may also the process logic and rules data including the business logic of an application or rules for a rules engine that implements the consumer advisor module.

The brokerage extends the result of any engagement to a physical point of care or service provider to allow continuation or escalation of services beyond those provided in the electronic encounter.

Embodiments can be implemented in digital electronic circuitry, or in computer hardware, firmware, software, or in combinations thereof. Apparatus of the invention can be implemented in a computer program product tangibly embodied or stored in a machine-readable storage device for execution by a programmable processor; and method actions can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD_ROM disks. Any of the foregoing can be supplemented by, or incorporated in, ASICs (application-specific integrated circuits).

Other embodiments are within the scope and spirit of the description claims. For example, due to the nature of software, functions described above can be implemented using software, hardware, firmware, hardwiring, or combinations of any of these. Moreover, while the description uses as an example medical provider and consumers that are patients the description is applicable to other experts in other fields outside of medicine. Features implementing functions may also be physically located at various positions, including being distributed such that portions of functions are implemented at different physical locations.

What is claimed is:

1. A computer-implemented method comprising:
receiving from a consumer a request to consult with a service provider;
calculating by one or more computers an estimate of when a service provider will be available to the consumer, based on determining entries in a queue maintained for the service provider, the entries corresponding to consumers waiting for the service provider;
adding by the one or more computers an entry corresponding to the consumer to the queue maintained for the suitable service provider;
sending by the one or more computers the estimate to a device used by the consumer; and when the consumer in the queue is at the top of the queue;
causing by the one or more computers establishment of a real-time communication channel with a device used by the consumer.

2. The method of claim 1, wherein the estimate further includes a number of entries corresponding to other consumers ahead of the entry of the consumer in the queue.

3. The method of claim 1, wherein the one or more computers generate a graphical user interface that is populated with the estimate.

4. The method of claim 1, further comprises for each entry added to the queue:
determining an estimate of an amount of time to allocate to each entry; and
associating the estimate of the amount of time with the corresponding entry in the queue.

5. The method of claim 4, wherein for the consumer calculating the estimate of when the service provider will be available to the consumer, further comprises:
determining which entries in the queue have a higher priority than a priority of the consumer; and
adding by the one or more computers allocated times of those entries in the queue that represent consumers having a higher priority than the consumer to calculate estimate.

6. The method of claim 1, further comprises:
determining by one or more computers a list of suitable service providers by matching attributes of service providers to metrics that define a suitable service provider that meets the consumer's preferences; and
receiving a selection one of the suitable service providers from the consumer providing the service provider.

7. The method of claim 1 further comprising:
assigning by the one or more computers to entries of consumers in the queue a priority by executing a priority algorithm.

8. The method of claim 1 further comprises:
calculating by the one or more computers estimates of lengths of the time of engagement by the consumers with the service provider;
adding the calculated estimates to entries for the consumer;
calculating by the one or more computers a total length of calculated times of engagement for those other consumers, having priorities greater than a priority of the consumer; and
sending the calculated total length to the device used by the consumer.

9. The method of claim 1, further comprises:
deleting an entry corresponding to a first one of the consumers waiting for the provider when the consult is completed; and
promoting entries in the queue corresponding to the remaining ones of the consumers waiting and the consumer.

10. The method of claim 1 wherein the request from the consumer includes medical information of the consumer for use during a consultation with the service provider.

11. A computer program product tangibly stored on a computer readable storage device for providing broker services to consumers and service providers, the computer program product comprising instructions for causing a computer to:
receive from a consumer a request to consult with a service provider;
calculate an estimate of when a service provider will be available to the consumer, based on determining entries in a queue maintained for the service provider, the entries corresponding to consumers waiting for the service provider;
add an entry corresponding to the consumer to the queue maintained for the suitable service provider;
send the estimate to a device used by the consumer; and when the consumer in the queue is at the top of the queue;
cause establishment of a real-time communication channel with a device used by the consumer.

12. The product of claim 11 wherein the estimate further includes a number of entries corresponding to other consumers ahead of the entry of the consumer in the queue.

13. The product of claim 11 wherein the one or more computers generate a graphical user interface that is populated with the estimate.

14. The product of claim 11, further comprises instructions to:
determine for each entry added to the queue an estimate of an amount of time to allocate to each entry; and
associate the estimate of the amount of time with the corresponding entry in the queue.

15. The product of claim 14 wherein for the consumer calculating the estimate of when the service provider will be available to the consumer, further comprises instructions to:
determine which entries in the queue have a higher priority than a priority of the consumer; and
add allocated times of those entries in the queue that represent consumers having a higher priority than the consumer to calculate estimate.

16. The product of claim 11, further comprises instructions to:
determine a list of suitable service providers by matching attributes of service providers to metrics that define a suitable service provider that meets the consumer's preferences; and
receive a selection one of the suitable service providers from the consumer providing the service provider.

17. The product of claim 11, further comprises instructions to:
assign entries of consumers in the queue a priority by executing a priority algorithm.

18. The product of claim 11, further comprises instructions to:
calculate estimates of lengths of the time of engagement by the consumers with the service provider;
add the calculated estimates to entries for the consumer;
calculate a total length of calculated times of engagement for those other consumers, having priorities greater than a priority of the consumer; and
send the calculated total length to the device used by the consumer.

19. The product of claim 11, further comprises instructions to:
delete an entry corresponding to a first one of the consumers waiting for the provider when the consult is completed; and
promoting entries in the queue corresponding to the remaining ones of the consumers waiting and the consumer.

20. The product of claim 19 wherein the request from the consumer includes medical information of the consumer for use during a consultation with the service provider.

21. An apparatus comprising:
a processor;
memory in communication with the processor; and
a computer program product tangibly stored on a computer readable storage device for providing broker services to consumers and service providers, the computer program product comprising instructions for causing a computer to:
receive from a consumer a request to consult with a service provider;
calculate an estimate of when a service provider will be available to the consumer, based on determining entries in a queue maintained for the service provider, the entries corresponding to consumers waiting for the service provider;
add an entry corresponding to the consumer to the queue maintained for the suitable service provider;
send the estimate to a device used by the consumer; and when the consumer in the queue is at the top of the queue;
cause establishment of a real-time communication channel with a device used by the consumer.

22. The apparatus of claim 21 wherein the estimate further includes a number of entries corresponding to other consumers ahead of the entry of the consumer in the queue.

23. The apparatus of claim 21 wherein the one or more computers generate a graphical user interface that is populated with the estimate.

24. The apparatus of claim 21 wherein the computer program product further comprises instructions to:
determine for each entry added to the queue an estimate of an amount of time to allocate to each entry; and
associate the estimate of the amount of time with the corresponding entry in the queue.

25. The apparatus of claim 21 wherein for the consumer calculating the estimate of when the service provider will be available to the consumer, further comprises instructions to:
determine which entries in the queue have a higher priority than a priority of the consumer; and
add allocated times of those entries in the queue that represent consumers having a higher priority than the consumer to calculate estimate.

26. The apparatus of claim 21 wherein the computer program product further comprises instructions to:
determine a list of suitable service providers by matching attributes of service providers to metrics that define a suitable service provider that meets the consumer's preferences; and
receive a selection one of the suitable service providers from the consumer providing the service provider.

27. The apparatus of claim 21 wherein the computer program product further comprises instructions to:
assign entries of consumers in the queue a priority by executing a priority algorithm.

28. The apparatus of claim 21 wherein the computer program product further comprises instructions to:
calculate estimates of lengths of the time of engagement by the consumers with the service provider;
add the calculated estimates to entries for the consumer;
calculate a total length of calculated times of engagement for those other consumers, having priorities greater than a priority of the consumer; and
send the calculated total length to the device used by the consumer.

29. The apparatus of claim 21 wherein the computer program product further comprises instructions to:
delete an entry corresponding to a first one of the consumers waiting for the provider when the consult is completed; and
promoting entries in the queue corresponding to the remaining ones of the consumers waiting and the consumer.

30. The apparatus of claim 21 wherein the request from the consumer includes medical information of the consumer for use during a consultation with the service provider.
